(19) United States
(12) Patent Application Publication
(10) Pub. No.: US 2016/0129317 A1
(43) Pub. Date: May 12, 2016

(54) METHOD FOR MAKING BALL

(71) Applicant: ANDREW WANG, TAIPEI CITY (TW)

(72) Inventor: ANDREW WANG, TAIPEI CITY (TW)

(21) Appl. No.: 14/535,429

(22) Filed: Nov. 7, 2014

(51) Int. Cl. A63B 45/00; B29C 35/02; B29C 67/00

(52) U.S. Cl. CPC A63B 45/00; B29C 67/0029; B29C 35/02; B29L 2031/545

(57) ABSTRACT

A method for making a ball provides a shortened manufacturing cycle and enhanced closeness between bound layers of the ball. The method includes providing a vacuum forming mold with two halves, opening the two halves, laying an outer cover in the vacuum forming mold, placing a yarn-wound bladder in the vacuum forming mold, closing the two halves of the mold, operating the vacuum forming mold to make the outer cover and the yarn-wound bladder combined tightly under vacuum and form a semi-finished ball, transferring the semi-finished ball into a vulcanizing mold, and heating the vulcanizing mold for vulcanization, thereby obtaining the ball. With the method, the rugby ball can be made effectively and have good quality due to the close combination between the layers.

### BACKGROUND OF THE INVENTION

1. Technical Field

The present invention relates to methods for making balls, and more particularly to a method for making rubber balls with a shortened manufacturing cycle and enhanced closeness between bound layers.

2. Description of Related Art

A rugby ball is formed by binding rubber pieces. FIG. 1 describes a conventional method for making a rubber ball. As shown, an outer rubber cover is adhered to a hollow yarn-wound bladder to form a semi-finished ball. When the adhesive under the outer cover is dried out, the semi-finished ball is placed into a vulcanizing mold and heated for vulcanization, so that the rubber of the outer cover is vulcanized and melted into a unitary piece, thereby forming a finished rugby ball. However, the conventional approach as described above has the following shortcomings:
(1) The inner and outer covers each consisting of several panels have to be manually adhesive panel by panel, so the manufacturing process is both time-consuming and labor-consuming.
(2) The two layers of adhesive need to be dried out over two separate periods, which prolongs the overall manufacturing cycle, and makes the manufacturing process less productive.
(3) The manual adhesion is disadvantageous for not only being time-consuming and labor-consuming, but also being more unlikely to achieve strict closeness between the inner cover and the yam-wound bladder, and between the outer cover and the inner cover. Once there is a bubble existing therebetween, the quality of the ball is ruined.

### SUMMARY OF THE INVENTION

The present invention is thus provided to improve the foregoing shortcomings of the conventional approach. The method involves providing a vacuum forming mold with two halves, opening the two halves, laying an outer cover in the vacuum forming mold, placing a yarn-wound bladder in the vacuum forming mold, closing the two halves of the mold, operating the vacuum forming mold to make the outer cover and the yarn-wound bladder combined tightly under vacuum and form a semi-finished ball, transferring the semi-finished ball into a vulcanizing mold, and heating the vulcanizing mold for vulcanization, thereby obtaining the ball as a finished rugby ball. By using the vacuum forming mold, close combination between the yam-wound bladder and the outer cover can be ensured, thereby improving the quality of the ball, shortening the manufacturing cycle, and reducing the overall manufacturing costs.

### BRIEF DESCRIPTION OF THE DRAWINGS

FIG. 1 is a flowchart of a conventional method for making a ball.

FIG. 2 is a flowchart of a method for making a ball according to the present invention.

FIG. 3 is a schematic drawing showing formation of the ball according to the present invention.

FIG. 4 is a cross-sectional view of the ball formed in a mold according to the present invention.

FIG. 5 is a perspective view of the post-vulcanization finished ball according to the present invention.

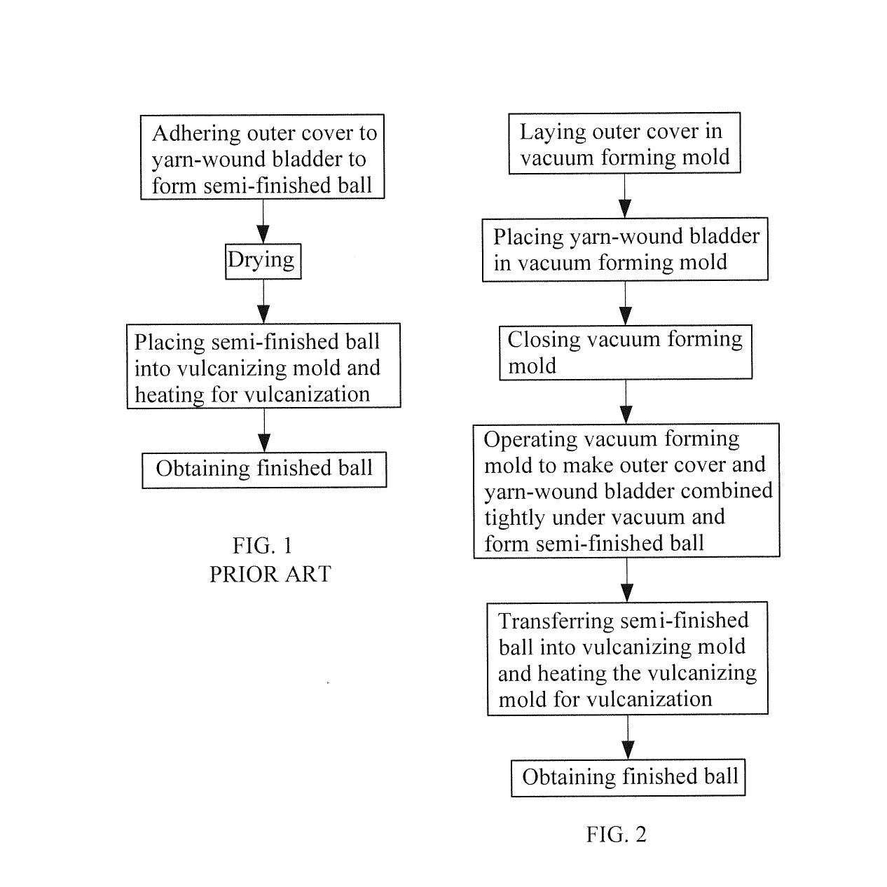

### DETAILED DESCRIPTION OF THE INVENTION

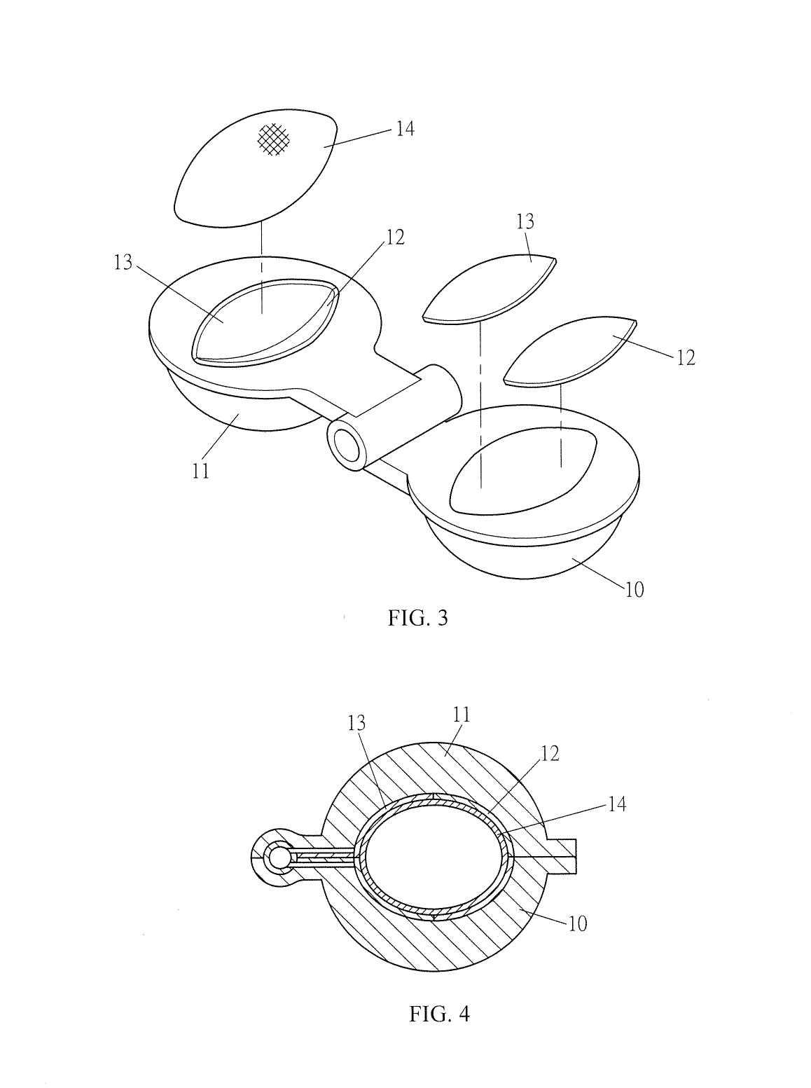

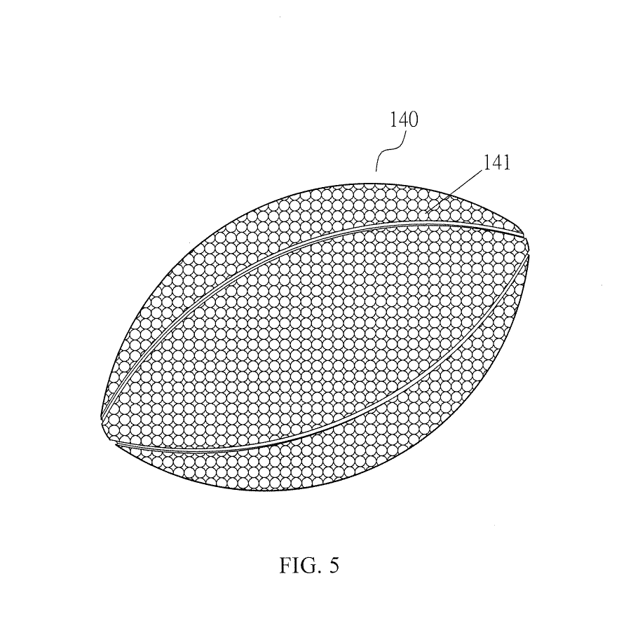

Referring to FIGS. 2, 3, 4 and 5, a vacuum forming mold has two halves 10 and 11 that can be opened and closed. Rubber Panels 12 and 13 constructing an outer cover (as shown in FIG. 3) are first laid into the two halves 10 and 11, and then a hollow yarn-wound bladder 14 is placed into the mold half 11. Afterward, the two mold halves 10 and 11 are closed (as shown in FIG. 4), and the vacuum forming mold is operated to vacuum a cavity defined by the two mold halves 10 and 11. The vacuum effect makes the rubber panels 12, 13 tightly attached to the yarn-wound bladder 14, so as to form a semi-finished ball 140. The semi-finished ball 140 is then transferred into a vulcanizing mold (not shown) and heated for vulcanization, so that a finished rugby ball with a patterned surface 141 is obtained, as shown in FIG. 5.

The disclosed method has the following beneficial features:
(1) With the cavity defined by the two halves 10 and 11, the rubber panels 12, 13 constructing the outer cover can be properly laid in the vacuum forming mold, so as to fully cover the yarn-wound bladder 14 after the mold is closed. This allows the adhesion to be performed in a quick yet precise manner.
(2) When the rubber panels 12, 13 are bound onto the yarn-wound bladder 14, the vacuum effect of the vacuum forming mold ensures there is no air bubble formed between the outer cover and the yarn-wound bladder 14. Understandably, this means truly tightness, so the quality of the finished ball is assured.
(3) Since the outer cover is tightly attached and shaped to the yarn-wound bladder 14 without any gaps therebetween, the shape of the finished ball is perfect.
(4) The vacuum effect can automatically form reliable adhesion, so the conventional adhering and pressing steps performed manually can be eliminated, so the manufacturing cycle is shorter and the overall manufacturing is more productive as compared to the prior art.
(5) As the adhesion is made tight, so the ball after vulcanization can form a perfectly unitary body.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A method for making a ball, the method comprising the following steps: providing a vacuum forming mold with two halves, opening the two halves, laying an outer cover in the vacuum forming mold, placing a yarn-wound bladder in the vacuum forming mold, closing the two halves of the mold, operating the vacuum forming mold to make the outer cover and the yarn-wound bladder combined tightly under vacuum and form a semi-finished ball, transferring the semi-finished ball into a vulcanizing mold, and heating the vulcanizing mold for vulcanization, thereby obtaining the ball as a finished rugby ball.
